(19) United States
(12) Patent Application Publication
(10) Pub. No.: US 2024/0255139 A1
(43) Pub. Date: Aug. 1, 2024

(54) Burner

(71) Applicant: SMS group GmbH, Düsseldorf (DE)

(72) Inventors: Björn KLUMBIES, Krefeld (DE); Günter GESCHE, Mönchengladbach (DE)

(73) Assignee: SMS group GmbH, Düsseldorf (DE)

(21) Appl. No.: 18/561,245

(22) PCT Filed: May 16, 2022
(86) PCT No.: PCT/EP2022/063200

§ 371 Date: Nov. 15, 2023

(30) Foreign Application Priority Data
May 17, 2021 (DE) 10 2021 204 972.9

(51) Int. Cl. F23D 14/10; C22C 1/02; F23D 14/58; F23D 14/64; F27B 1/08; F27D 99/00

(52) U.S. Cl. CPC F23D 14/105; C22C 1/02; F23D 14/58; F23D 14/64; F27B 1/08; F27D 99/0033; F23D 2203/002; F23D 2900/14021; F23D 2900/14241; F27D 2099/0045

(57) ABSTRACT

The present application relates to a burner for a shaft melting furnace, in particular for a copper shaft melting furnace, comprising a first chamber with an inlet opening, via which an oxygen-containing gas can be supplied to the burner, and an outlet opening, which is arranged at a distal end of a conically tapering sub-portion of the first chamber; a second chamber, which is connected to the conical sub-portion of the first chamber and which has a burner nozzle; a combustion gas line, which opens into the first chamber and via which a combustion gas can be supplied to the burner; and a mixing nozzle, which is arranged in the outlet opening of the first chamber and which has a mixing chamber via which the oxygen-containing gas and the combustion gas can be mixed to form a combustion gas mixture.

### CROSS-REFERENCE TO RELATED APPLICATION

This application is a national stage application, filed under 35 U.S.C. § 371, of International Patent Application PCT/EP2022/063200, filed on May 16, 2022, which claims the benefit of German Patent Application DE 10 2021 204 972.9, filed on May 17, 2021.

### TECHNICAL FIELD

The present disclosure relates to a burner for a shaft melting furnace, in particular for a copper shaft melting furnace, and to a shaft melting furnace, in particular a copper shaft melting furnace, comprising the at least one burner.

### BACKGROUND

Whether in electrical engineering and electronics, in heating and air-conditioning technology or in the automotive industry—it is impossible to imagine modern life without the use of copper and copper alloys, as a result of which global demand for this precious metal is constantly increasing. However, global demand is offset by increased safety and environmental requirements for production. Powerful burners, among other things, are indispensable for this purpose.

Burners for a shaft melting furnace are generally known from the prior art. For example, WO 90/02909 discloses a generic burner with a conically shaped first chamber, an adjoining mixing chamber along with a telescopic eyepiece that extends axially through the burner. The burner known from WO 90/02909 exhibits substantially complete combustion and a uniform flame composition, but on the one hand does not satisfy today's increased environmental requirements and on the other hand does not enable permanent flame monitoring.

### SUMMARY

The present disclosure provides an improved a burner over those known from the prior art in such a manner that it is improved in terms of its energy balance. The burner enables homogeneous mixing between an oxygen-containing gas and a combustion gas while simultaneously reducing pressure loss.

The burner is provided for a shaft melting furnace, in particular for a copper shaft melting furnace, and comprises a first chamber with an inlet opening, via which an oxygen-containing gas, such as air, oxygen-enriched air or pure oxygen, can be supplied to the burner, and an outlet opening, which is arranged at a distal end of a conically tapering sub-portion of the first chamber; and a second chamber, which connected to the conical sub-portion of the first chamber and which has a burner nozzle.

The burner comprises a combustion gas line, which opens into the first chamber and via which a combustion gas can be supplied to the burner; and a mixing nozzle, which is arranged in the outlet opening of the first chamber and which has a mixing chamber via which the oxygen-containing gas and the combustion gas can be mixed to form a combustion gas mixture.

Suitable combustion gases include hydrocarbon gases, in particular methane or natural gas, hydrogen or mixtures thereof. The mixture, for example one of natural gas or methane and hydrogen, is advantageously premixed individually in the range of 1 to 100% by volume, for example in a valve station, and then fed to the burner via the combustion gas line. One advantage of blending hydrogen with the hydrocarbon-containing gas is that it allows a flexible response to rising CO2 prices in the future. Thereby, it is particularly preferred that the hydrogen has been obtained by means of renewable energies.

By arranging the fuel gas line within the first chamber, which serves as a collection chamber for the oxygen-containing gas, the combustion gas is premixed with the oxygen-containing gas. The premixed fuel gas mixture then flows through the mixing nozzle arranged in the outlet opening and is then homogeneously mixed in the mixing chamber, which advantageously has a specific mixing geometry. Thereby, the entire mixing nozzle is designed in such a manner that it causes a particularly low pressure loss of only 70 mbar. This ultimately ensures that the permanent pressure loss at the burner can be continuously kept to a minimum, as a result of which the burner has a better energy balance compared with burners known from the prior art.

Further advantageous embodiments of the invention are indicated in the dependent formulated claims. The features listed individually in the dependent formulated claims can be combined with one another in a technologically useful manner and may define further embodiments of the invention. In addition, the features indicated in the claims are further specified and explained in the description, wherein further preferred embodiments of the invention are shown.

In order to further increase the first intermixing between the oxygen-containing gas and the combustion gas within the first chamber, it is advantageously provided that the combustion gas line opens into the conically tapering sub-portion of the first chamber, and particularly preferably comprises at least one or a plurality of nozzle openings, by means of which the combustion gas can be supplied at an angle of 30° to 60° with respect to a longitudinal axis of the burner to the oxygen-containing gas, which is substantially rectified as it flows through the conical sub-portion of the first chamber.

As already explained, the mixing nozzle causes a particularly low pressure loss, which has an energetically advantageous effect on the operation of the burner. The low pressure loss is achieved by the specific mixing geometry, which is advantageously formed by a plurality of blades arranged in the mixing chamber. The mixing chamber is formed to be annular and has an inner ring and an outer ring. Within the annular mixing chamber, the mixing nozzle preferably has a first set of blades arranged radially outwardly and a second set of blades arranged radially inwardly, wherein the two sets of blades are arranged in opposite directions to one another, preferably in such a manner that each blade of the first set forms three shear planes with three blades of the second set, or each blade of the second set forms three shear planes with three blades of the first set, as the case may be. This arrangement ensures that the combustion gas mixture flowing over the blade surfaces of the radially outwardly arranged blades strikes the blade surfaces of the radially inner blades, which are arranged substantially perpendicularly thereto, and thereby mixes with the combustion gas mixture flowing over the blade surfaces of the radially inner blades and vice versa. This multiple intermixing of the already premixed combustion gas mixture achieves homogeneous mixing of the two gases while keeping permanent pressure loss low.

In an advantageous embodiment, the burner further comprises an observation device with a viewing axis extending through the first chamber, the mixing nozzle, the second chamber and the burner nozzle, via which the exit region of the burner as well as the flame chamber of the shaft melting furnace can be monitored by an operator or by means of a camera module, in order to be able to react to malfunctions in the flame chamber.

Advantageously, the observation device for this purpose comprises a tube that extends axially through the first chamber, wherein a first end of the tube is arranged outside the burner and comprises an inspection glass and/or a camera module, and a second end of the tube is arranged in a central opening of the mixing nozzle and is locked, for example, by means of a bayonet lock. From the point of view of fluid dynamics, it has been shown that a combustion gas line arranged coaxially around the tube of the observation device is particularly advantageous. Therefore, it is preferably provided in this connection that the fuel gas line is arranged coaxially around the tube of the observation device and comprises at its end oriented towards the mixing nozzle a plurality of nozzle openings, which are particularly preferably arranged in a manner distributed over the circumference thereof. Each of the plurality of nozzle openings is oriented at an angle of 40° to 50°, preferably at an angle of 45°, with respect to the visual or longitudinal axis, as the case may be, of the burner, in order to achieve a particularly high first cut between the fuel gas flowing out of the nozzle openings and the oxygen-containing gas.

The burner nozzle, which advantageously comprises a plurality of guide blades, is arranged at the end of the second chamber axially opposite the mixing nozzle. These are arranged in a front region of the burner nozzle in the direction of flow. The guide blades are designed and aligned relative to one another in such a manner that the combustion gas mixture is driven to the center of the channel, which generates turbulence in the center region on a targeted basis and thus prevents the free flow of the combustion gas mixture. This ensures that, while maintaining the viewing axis, a homogeneous speed profile is achieved over the entire cross-section of the radiant tube and that the combustion gas mixture has reacted completely before hitting the melting material to be melted down, such that there are no strands without a reaction.

In the rear region in the direction of flow, the burner nozzle then has a conically tapering outlet opening, the edge of which, in accordance with an advantageous embodiment, has a serrated structure, in particular one provided with recesses, via which turbulence can be generated in a targeted manner, which leads to the formation of a stable flame root. In the present case, the burner is ignited by means of an ignition ionization candle, which is arranged just behind the edge, and is advantageously continuously monitored by an ionization monitor. For this purpose, it is necessary that the monitoring wire is always positioned in the flame throughout the entire output spectrum of the burner. Due to the formation of the stable flame root, this can be guaranteed at all times.

In a further aspect, the present disclosure further relates to a shaft melting furnace, in particular a copper shaft melting furnace, comprising at least one, more preferably a plurality of the burners. In this connection, it is preferably provided that at least one, preferably all, of the burners is or are, as the case may be, arranged at an inclined angle with respect to a horizontal line in a wall of the shaft melting furnace.

### BRIEF DESCRIPTION OF THE DRAWINGS

The invention and the technical environment are explained in more detail below with reference to the figures. It should be noted that the invention is not intended to be limited by the exemplary embodiments shown. In particular, unless explicitly shown otherwise, it is also possible to extract partial aspects of the facts explained in the figures and combine them with other components and findings from the present description and/or figures. In particular, it should be noted that the figures and in particular the size relationships shown are only schematic. Identical reference signs designate identical objects, such that explanations from other figures can be used as a supplement if necessary. The following are shown:

FIG. 1 an embodiment of a burner in a perspective view,

FIG. 2 the embodiment of the burner shown in FIG. 1 in a sectional view,

FIG. 3 an embodiment of the tube with the combustion gas line in a perspective view,

FIG. 4 an embodiment of the mixing nozzle in a perspective view,

FIG. 5 the embodiment shown in FIG. 4 of the mixing nozzle in a sectional view,

FIG. 6 an embodiment of the burner nozzle in a perspective view,

FIG. 7 the embodiment shown in FIG. 6 of the burner nozzle in a sectional view, and

FIG. 8 the embodiment shown in FIGS. 6 and 7 of the burner nozzle in a front view.

### DETAILED DESCRIPTION

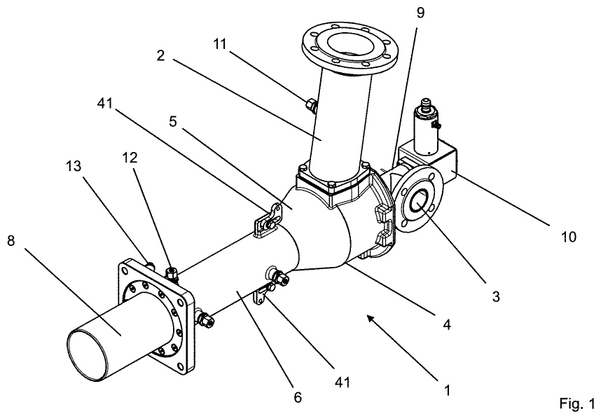

FIG. 1 shows an embodiment of the burner 1 in a perspective view, which can, in principle, be used in all metallurgical melting units in which visual monitoring of the combustion chamber is required. Preferably, however, the burner 1 is provided to be used in a copper shaft melting furnace (not shown), in which copper cathodes are melted down in order to recover copper.

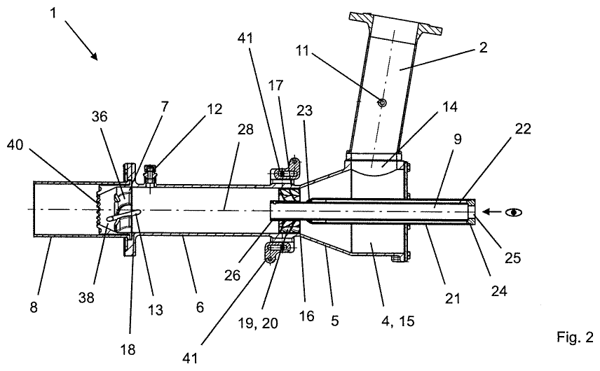

The burner 1 shown in the present embodiment comprises a first connecting piece 2, via which an oxygen-containing gas, such as air, can be fed to the burner 1, and a second connecting piece 3, via which a combustion gas can be fed to the burner 1. For example, the combustion gas can comprise a hydrocarbon-containing gas, such as natural gas or methane, hydrogen or a mixture thereof. Furthermore, the burner 1 comprises a first chamber 4 that has a conical sub-portion 5, a second chamber 6 having a burner nozzle 7 (see FIG. 2) along with a radiant tube 8. In the present case, the radiant tube 8 is made of silicon carbide. In the rear part, the burner 1 also has an observation device 9 along with a camera module 10, via which visual monitoring of the combustion chamber can be carried out. As can be seen from the representation in FIG. 1, the burner 1 further has a first measuring connection 11, which is arranged in the first connecting piece 2, and a second measuring connection 12, which is arranged at a distal end of the second chamber 6. The two measuring connections 11, 12 can be used, for example, to detect the volume flow rates and/or the composition of the oxygen-containing gas or the fuel gas mixture, as the case may be. Furthermore, an ignition ionization candle 13 is arranged at the distal end of the second chamber 6, via which the combustion gas mixture in the burner nozzle 7 can be ignited and the flame can be monitored immediately afterwards. The burner 1 shown in FIG. 1 is designed for a throughput of 900 Nm3/h and has a pressure loss of only 90 mbar.

In order to be able to install the burner 1 ergonomically, it has two crane lugs 41 on the outer side of the second chamber 6, which are located at the center of gravity and in each case comprise an elongated hole, in order to compensate for changes in the center of gravity that may result from supplementary attachments.

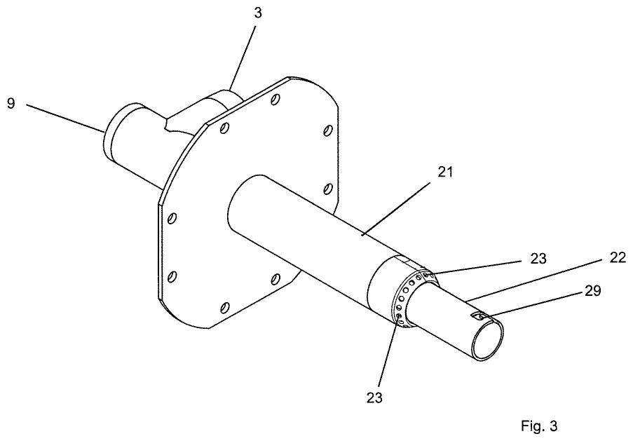

The burner 1 can be fed with the oxygen-containing gas both from above, as shown in FIGS. 2 and 3, and from below. If it is advantageous to feed the oxygen-containing gas from below, the burner 1 is rotated by 180°. The second connecting piece 3, via which the combustion gas can be fed to burner 1, can also be mounted rotated by 90° steps, depending on the installation conditions, wherein the axial structure does not affect the action of the burner 1.

FIG. 2 shows the embodiment of the burner 1 shown in FIG. 1 in a sectional view, but without the camera module 10.

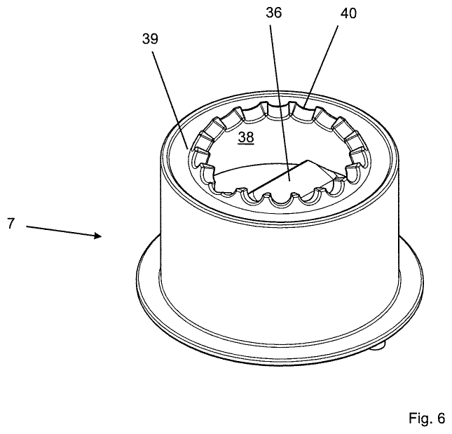

On the one hand, such representation shows the first chamber 4, which has an inlet opening 14, via which the oxygen-containing gas is introduced into the first chamber 4 via the first connecting piece 2. The first chamber 4 comprises, in addition to a main section 15 into which the inlet opening 14 opens, the conically tapering sub-portion 5 which has an outlet opening 16 arranged at its distal end. Connected to the conical sub-portion 5 of the first chamber 4 is the second chamber 6, which is formed from a hollow cylindrical element, for example a tube, and has a first end 17 facing the conical sub-portion 5 along with an axially opposite second end 18, at which the burner nozzle 7 is arranged. In the present case, the burner nozzle 7 is made of steel by means of an additive manufacturing process and is explained in more detail in FIGS. 6 to 8.

A mixing nozzle 19 with a mixing chamber 20 is arranged at the first end 17 of the second chamber 6 or in the outlet opening 16 of the first chamber 4, as the case may be, via which the oxygen-containing gas and the fuel gas can be mixed to form a fuel gas mixture. Thereby, the fuel gas is introduced into the burner 1 via a fuel gas line 21, which opens out in the first chamber 4, in particular in the conically tapering partial section 5 of the first chamber 4.

As can be seen from the representation in FIG. 2, the combustion gas line 21 in the embodiment shown here is arranged coaxially around a tube 22 of the observation device 9 and has a plurality of nozzle openings 23 at its end oriented towards the mixing nozzle 19, which are arranged in a manner distributed over the circumference thereof (see FIG. 3). Thereby, each of the nozzle openings 23 is oriented at an angle of 40° to 50° with respect to a viewing axis 28 of the burner 1, in order to achieve a first cut between the combustion gas flowing out of the nozzle openings 23 and the oxygen-containing gas that flows through the first chamber 4. The combustion gas mixture premixed in this manner upstream of the mixing nozzle 19 then flows through the mixing nozzle 19.

The tube 22 of the observation device 9, which extends axially through the first chamber 4, has a first end 24. This is arranged outside the burner 1 and comprises an inspection glass 25 or alternatively the camera module 10 (FIG. 1), via which visual monitoring of the combustion chamber can be carried out. The inspection glass 25 allows an operator to look into the interior of a shaft melting furnace along the viewing axis 28 extending through the first chamber 4, the mixing nozzle 19, the second chamber 6 and the burner nozzle 7, in order to identify malfunctions. Furthermore, the tube 22 comprises a second end 26, which is arranged in a central opening 27 of the mixing nozzle 19 and is connected to the latter in a fixed position via a bayonet lock 29 (see FIG. 3).

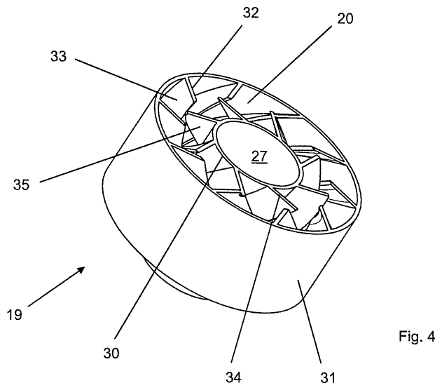

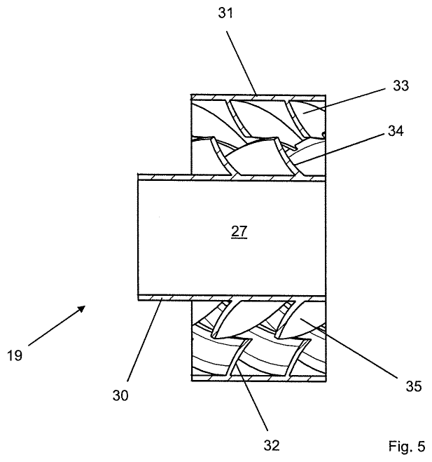

FIGS. 4 and 5 show the mixing nozzle 19 with its specific mixing geometry, which in the present case, like the burner nozzle 7, has been produced by means of an additive manufacturing process, but unlike the latter, is made of silicon carbide. In the embodiment shown in the present case, the mixing nozzle 19 has an annular mixing chamber 20, which is bounded by an inner ring 30 and an outer ring 31 arranged radially opposite. Inside the mixing chamber 19, the blades 32, 34 are arranged, via which the premixed combustion gas mixture can be homogeneously mixed by multiple intermixing in the direction of flow. Specifically, the mixing chamber 20 comprises a first set of radially outwardly arranged blades 32 that are carried by the outer ring 31 and a second set of radially inwardly arranged blades 34, arranged opposite the first set, that are carried by the inner ring 30. The blades 32, 34 of the two sets are arranged in the circumferential direction relative to one another in such a manner that each blade 32 of the first set forms three shear planes with each three blades 34 of the second set, and each blade 34 of the second set forms three shear planes with each three blades 32 of the first set, as the case may be. In other words, the combustion gas mixture flowing over the blade surfaces 33 of the radially outwardly arranged blades 32 is directed onto the blade surfaces 35 of the radially inner blades 34, which are arranged substantially perpendicularly thereto, and thereby mixes with the combustion gas mixture flowing over the blade surfaces 35 of the radially inner blades 34 and vice versa. In addition, each of the plurality of the blades 32, 34 has a slightly curved shape in cross-section.

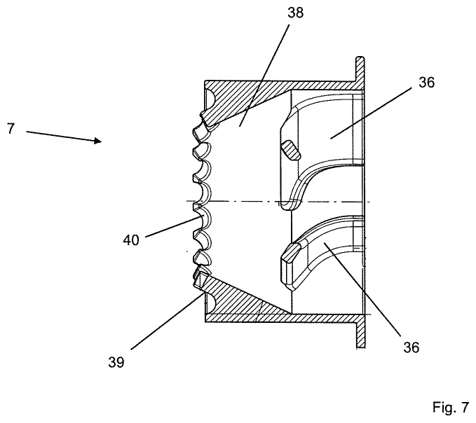

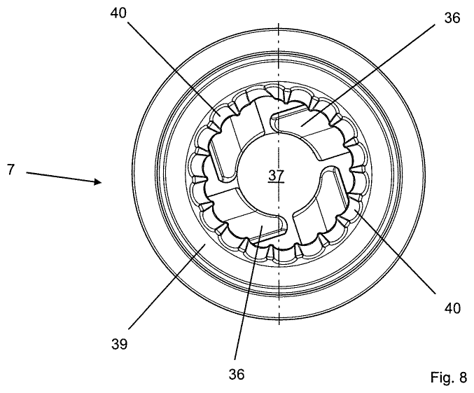

FIGS. 6 to 8 show an embodiment of the burner nozzle 7 in different representations. This consists substantially of a hollow cylindrical element and has a plurality of guide blades 36 in a front region, via which the combustion gas mixture can initially be guided through a central channel 37 formed between the guide blades 36 (FIG. 8). As can be seen from the representation in FIG. 7, the individual guide blades 36 have an arc-shaped bend for this purpose, as a result of which the combustion gas mixture is initially forced into the center as it flows through the front region of the burner nozzle 7 before it passes through the channel 37. This is substantially defined by the distal end sections of the individual guide blades 36 (FIG. 8). In the direction of flow immediately behind it, the burner nozzle 7 has a conically tapering outlet opening 38, the surrounding end face or edge 39, as the case may be, of which has a structure provided with recesses 40.

### LIST OF REFERENCE SIGNS

1 Burner
2 First connecting piece
3 Second connecting piece
4 First chamber
5 Conical sub-portion
6 Second chamber
7 Burner nozzle
8 Radiant tube
9 Observation device
10 Camera module
11 First measuring connection
12 Second measuring connection
13 Ignition ionization candle
14 Inlet opening
15 Main section
16 Outlet opening
17 First end of the second chamber
18 Second end of the second chamber
19 Mixing nozzle
20 Mixing chamber
21 Combustion gas line
22 Tube
23 Nozzle openings
24 First end of the tube
25 Inspection glass
26 Second end of the tube
27 Central opening
28 Viewing axis
29 Bayonet lock
30 Inner ring
31 Outer ring
32 First set of blades
33 Blade surface of radially outer blades
34 Second set of blades
35 Blade surface of radially inner blades
36 Guide blades
37 Channel
38 Conically tapering outlet opening of burner nozzle
39 End face/edge
40 Recesses

1.-15. (canceled)

16. A burner (1) for a shaft melting furnace, comprising:
a first chamber (4) with
an inlet opening (14), via which an oxygen-containing gas can be supplied to the burner (1), and
an outlet opening (16), which is arranged at a distal end of a conically tapering sub-portion (5) of the first chamber (4);
a second chamber (6), which is connected to the conically tapering sub-portion (5) of the first chamber (4) and which has a burner nozzle (7);
a combustion gas line (21), which opens into the first chamber (4) and via which a combustion gas can be supplied to the burner (1); and
a mixing nozzle (19), which is arranged in the outlet opening (16) of the first chamber (4) and which has a mixing chamber (20) via which the oxygen-containing gas and the combustion gas can be mixed to form a combustion gas mixture.

17. The burner (1) according to claim 16,
wherein the combustion gas line (21) opens into the conically tapering sub-portion (5) of the first chamber (4).

18. The burner (1) according to claim 16,
wherein the mixing nozzle (19) comprises a plurality of blades (32, 34), which are arranged in the mixing chamber (20), and
wherein the mixing chamber (20) is annular.

19. The burner (1) according to claim 18,
wherein the annular mixing chamber (20) comprises
a first set of blades (32) arranged radially outwardly and
a second set of blades (34) arranged radially inwardly,
wherein blades of the first set of blades (32) are arranged in opposite direction to blades of the second set of blades (34).

20. The burner (1) according to claim 16, further comprising
an observation device (9) with a viewing axis (28) extending through the first chamber (4), the mixing nozzle (19), the second chamber (6) and the burner nozzle (7), via which a flame chamber of the shaft melting furnace can be monitored.

21. The burner (1) according to claim 20,
wherein the observation device (9) comprises a tube (22) that extends axially through the first chamber (4),
wherein a first end (24) of the tube (22) is arranged outside the burner (1) and comprises an inspection glass (25) and/or a camera module (10), and
wherein a second end (26) of the tube (22) is arranged in a central opening (27) of the mixing nozzle (19).

22. The burner (1) according to claim 21,
wherein the combustion gas line (21) is arranged coaxially around the tube (22) of the observation device (9) and comprises at its end oriented towards the mixing nozzle (19) a plurality of nozzle openings (23), which are arranged distributed over a circumference thereof.

23. The burner (1) according to claim 16,
wherein the burner nozzle (7) comprises a plurality of guide blades (36), which are arranged in a front region of the burner nozzle (7).

24. The burner (1) according to claim 16,
wherein the burner nozzle (7) comprises a conically tapering outlet opening (38), which is arranged in a rear region of the burner nozzle (7).

25. The burner (1) according to claim 24,
wherein the conically tapering outlet opening (38) has an edge (39) having a serrated structure provided with recesses (40).

26. The burner (1) according to claim 16,
wherein the mixing nozzle (19) and/or the burner nozzle (7) is made of silicon carbide.

27. The burner (1) according to claim 16,
further comprising at least two measuring connections (11, 12).

28. The burner (1) according to claim 16,
further comprising a radiant tube (8) consisting of silicon carbide (SiC).

29. A copper shaft melting furnace, comprising at least one burner (1) according to claim 16

30. The shaft melting furnace according to claim 29, wherein the at least one burner (1) is arranged at an inclined angle with respect to a horizontal line in a wall of the shaft melting furnace.
